(19) United States
(12) Patent Application Publication
(10) Pub. No.: US 2026/0004097 A1
(43) Pub. Date: Jan. 1, 2026

(54) LIQUID DROPLET EJECTING APPARATUS, LIQUID DROPLET EJECTING METHOD, AND MEDIUM STORING PROGRAM FOR LIQUID DROPLET EJECTING APPARATUS

(71) Applicant: BROTHER KOGYO KABUSHIKI KAISHA, Nagoya (JP)

(72) Inventor: Seiya SATO, Yokkaichi (JP)

(73) Assignee: BROTHER KOGYO KABUSHIKI KAISHA, Nagoya (JP)

(21) Appl. No.: 19/237,083

(22) Filed: Jun. 13, 2025

(30) Foreign Application Priority Data
Jun. 27, 2024 (JP) 2024-104031

(51) Int. Cl. G06K 15/02; B41J 2/045; B41J 2/165; G06K 15/00

(52) U.S. Cl. CPC G06K 15/1868; B41J 2/04536; B41J 2/04563; B41J 2/04566; B41J 2/04586; B41J 2/1652; G06K 15/407; G06K 15/408; B41J 2002/16573

(57) ABSTRACT

A liquid droplet ejecting apparatus includes an ejection head having first nozzles configured to eject a first liquid to a printing medium and second nozzles configured to eject a second liquid different from the first liquid to the printing medium; a memory; and a controller. The memory stores a first lookup table for converting image data into first printing data for using only the first liquid and a second lookup table for converting the image data into second printing data for using both of the first liquid and the second liquid. The controller is configured to cause the ejection head to eject liquid droplets to the printing medium based on the first lookup table or the second lookup table, depending on dryness of the second nozzles.

### REFERENCE TO RELATED APPLICATIONS

This application claims priority from Japanese Patent Application No. 2024-104031 filed on Jun. 27, 2024. The entire content of the priority application is incorporated herein by reference.

### BACKGROUND ART

A known printing apparatus includes first nozzles configured to print an image on a printing medium based on image data by using a predetermined basic color ink and second nozzles configured to print an image on the printing medium based on the image data by using a special color ink that are different from the basic color ink. The basic color ink is exemplified by a cyan ink, a yellow ink, a magenta ink, and a black ink. On the other hand, the special color ink includes an ink having a color different from the color of the basic color ink, and is exemplified, for example, by a red ink, a green ink, and a blue ink.

### SUMMARY

The special color ink has such a tendency that the special color ink is used less frequently. On this account, the nozzles configured to eject the special color ink are likely to dry relatively easily. As a result, the nozzles configured to eject the special color ink has such a problem that the ejection failure is likely to occur easily in the nozzles configured to eject the special color ink.

In view of the above-described situation, the present disclosure aims to provide a liquid droplet ejecting apparatus, a liquid droplet-ejecting method, and a medium storing a program for the liquid droplet ejecting apparatus according to each of which the occurrence of ejection failure can be reduced in the nozzles configured to eject the special color ink.

A liquid ejecting apparatus according to the present disclosure includes: an ejection head having first nozzles configured to eject a first liquid to a printing medium and second nozzles configured to eject a second liquid different from the first liquid to the printing medium; a memory; and a controller. The memory stores a first lookup table for converting image data into first printing data for using only the first liquid and a second lookup table for converting the image data into second printing data for using both of the first liquid and the second liquid. The controller is configured to execute a process of causing the ejection head to eject liquid droplets to the printing medium based on the first lookup table or the second lookup table depending on dryness of the second nozzles.

According to the present disclosure, the memory stores the second lookup table which is usable to convert the image data into the second printing data. Further, the liquid droplets are ejected to the printing medium based on the second lookup table, depending on the dryness of the second nozzles. In this way, the second liquid is ejected while being overlapped with the first liquid based on the second lookup table to a region, in the printing medium, in which the ejection of the second liquid is not originally necessary. Thus, a periodic ejection of the second liquid is realized by the second nozzles. Accordingly, the occurrence of drying in the second nozzles is reduced, and the occurrence of ejection failure can be made less likely.

According to the present disclosure, the liquid droplet ejecting apparatus, the liquid droplet ejecting method, and the medium storing the program for the liquid droplet ejecting apparatus, each capable of reducing the occurrence of ejection failure in the nozzles configured to eject the special color ink, can be realized.

### BRIEF DESCRIPTION OF DRAWINGS

FIG. 1 is a plan view depicting the configuration of a liquid droplet ejecting apparatus according to an embodiment.

FIG. 2 is a view of nozzle arrays in each of ejection heads depicted in FIG. 1.

FIG. 3 is a block diagram depicting the configuration of a control system of the liquid droplet ejecting apparatus depicted in FIG. 1.

FIG. 4 is a view depicting an example of a first lookup table.

FIG. 5A is a view depicting an example of a second lookup table including a first special color ink, and FIG. 5B is a view depicting an example of a second lookup table including a second special color ink.

FIG. 6 is a view depicting an example of a second lookup table in which a certain color difference occurs.

FIGS. 7A and 7B are a flow chart indicating an example of the flow of a process in the liquid droplet ejecting apparatus.

FIGS. 8A and 8B are a flow chart indicating an example of the flow of a process in the liquid droplet ejecting apparatus.

FIG. 9A is a view depicting an original image, FIG. 9B is a view depicting a frequency map, and FIG. 9C is a view depicting a color difference map.

FIG. 10 is a view indicating the relationship between a permissible amount of the color difference and a frequency component.

### DESCRIPTION

A liquid droplet ejecting apparatus according to an embodiment of the present disclosure will be described below with reference to the drawings. The liquid droplet ejecting apparatus described below is merely an embodiment of the present disclosure. Therefore, the present disclosure is not limited to the following embodiment, and addition, deletion, and change can be made within the range not departing from the gist or characteristics of the present disclosure. Note that in the following description, the same reference numerals are affixed to the same or corresponding elements throughout all the drawings, and any overlapping explanation will be omitted unless otherwise noted.

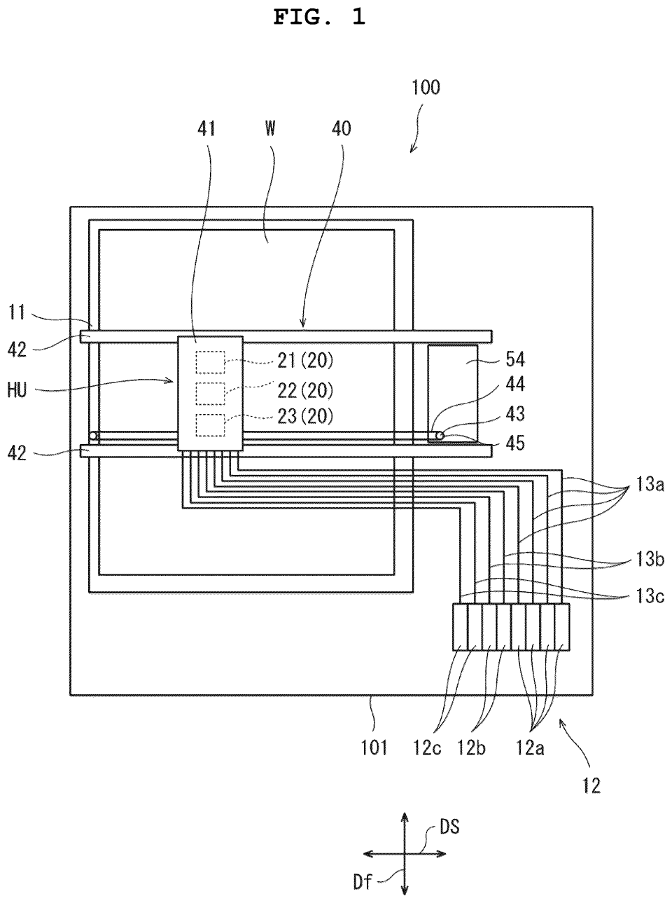

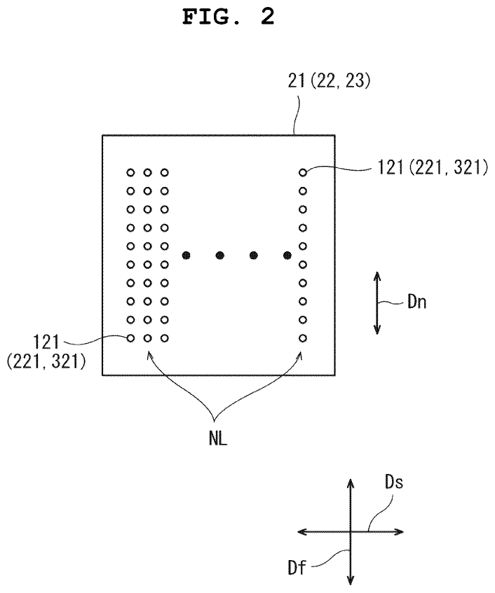

With reference to FIG. 1 and FIG. 2, mutually orthogonal directions are designated as “first direction Df” and “second direction Ds”. In the present embodiment, for example, the first direction Df is a conveyance direction of a printing medium W, and the second direction Ds is a movement direction of a carriage 41 described later. In the following description, Ds is referred to as “movement direction”, and Df is referred to as “conveyance direction”. However, the foregoing directions are referred to by way of example, to which the present disclosure is not limited.

The liquid droplet ejecting apparatus 100 is, for example, an ink-jet printer based on the serial head system. The liquid droplet ejecting apparatus 100 alternately repeats, based on the printing data, a pass process of ejecting ink droplets while moving an ink-jet head (hereinafter referred to as “head”) 20 in the movement direction Ds, and the conveying process of conveying the printing medium W in the conveyance direction Df. With this, a predetermined image is printed on the printing medium W. Note that an example of the printing medium W includes, for example, cloth and a sheet film.

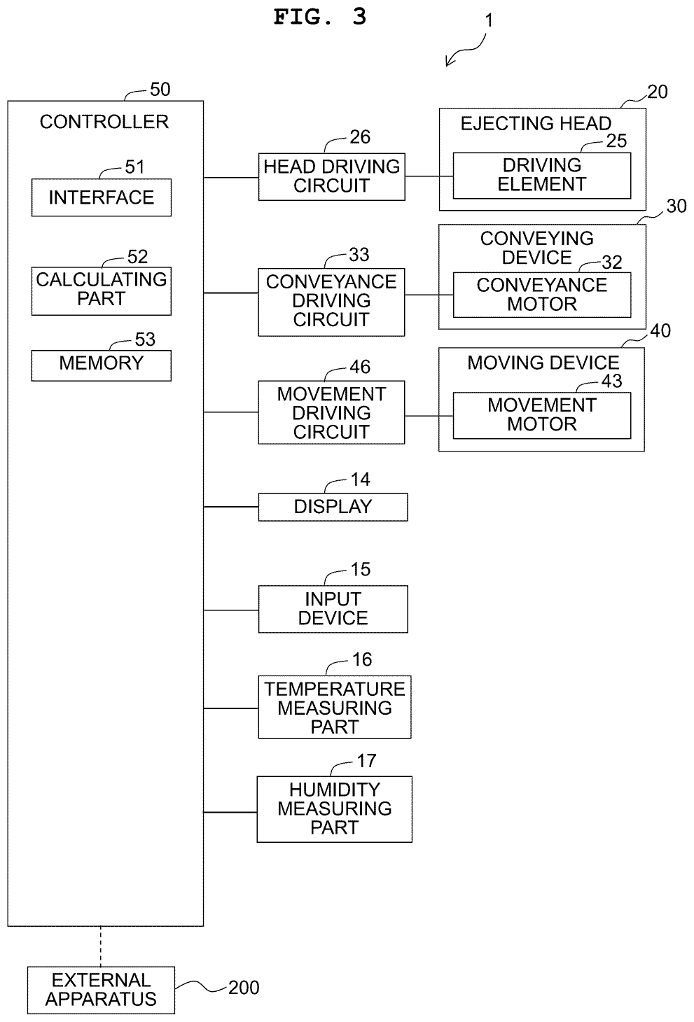

As depicted in FIG. 1 and FIG. 3, the liquid droplet ejecting apparatus 100 includes an ejection head unit HU which has a plurality of ejection heads 20, a platen 11, a plurality of tanks 12, a conveying device 30, a moving device 40, a receiving part 54, and a casing 101.

The ejection head 20 prints an image on the printing medium W using predetermined ink droplets based on printing data. The plurality of ejection heads 20, which are included in the ejection head unit HU, are exemplified by a first ink-jet head (hereinafter referred to as “first ejection head”) 21, a second ink-jet head (hereinafter referred to as “second ejection head”) 22, and a third ink-jet head (hereinafter referred to as “third ejection head”) 23. The ejection heads are disposed and aligned in the order of the first ejection head 21, the second ejection head 22, and the third ejection head 23, from one side in the conveyance direction Df. In the following description, in a case where the ejection head 20 is described, the ejection head 20 includes the first ejection head 21, the second ejection head 22, and the third ejection head 23. In the present embodiment, for example, the first ejection head 21 performs the printing on the printing medium W using a white ink, the second ejection head 22 performs the printing on the printing medium W using a special color ink, and the third ejection head 23 performs the printing on the printing medium W using a color ink. However, the foregoing colors of the inks ejected, respectively, from the first ejection head 21, the second ejection head 22 and the third ejection head 23 are merely examples, and the colors can be appropriately changed.

The platen 11 has a flat upper surface. The platen 11 defines the distance between the printing medium W, which is to be placed on the upper surface of the platen 11, and the nozzle surface of each of the ejection heads 20 which faces the printing medium W. The platen 11 reciprocates in the conveyance direction Df. Accordingly, the printing medium W, which is supported by the platen 11, reciprocates in the conveyance direction Df.

Each of the inks is stored in a corresponding one of the plurality of tanks 12. Each of the plurality of tanks 12 is connected to a corresponding one of the plurality of ejection heads 20 via flow passages described later, in order to supply the inks to the plurality of ejection heads 20. Each of the plurality of tanks 12 is a container configured to store the ink. The number of the tanks 12 is the same as or more than the number of types of the inks. For example, the tanks 12 include: four first tanks 12a configured to store, respectively, four types of color inks; one second tank 12b or a plurality of second tanks 12b configured to store a white ink, and one third tank 12c configured to store one special color ink or a plurality of third tanks 12c configured to store a plurality of special color inks. Note that the color ink is exemplified by cyan ink, magenta ink, yellow ink, and black ink. Further, the special color ink is exemplified, for example, by orange ink, green ink, and red ink.

Each of the four first tanks 12a communicates with the third ejection head 23 via a corresponding one of first flow passages 13a. The color inks are supplied from the first tanks 12 to the third ejection head 23 via the first flow passages 13a. The second tank(s) 12b communicate(s) with the first ejection head 21 via a second flow passage(s) 13b. The white ink is supplied from the second tank(s) 12b to the first ejection head 21 via the second flow passage(s) 13b. The third tank(s) 12c communicate(s) with the second ejection head 22 via a third flow passage(s) 13c. The special color ink(s) is (are) supplied from the third tank(s) 12c to the second ejection head 22 via the third flow passage(s) 13c. Note that in the present embodiment, the color ink corresponds to a first liquid, and the special color ink corresponds to a second liquid which is different from the first liquid.

The conveying device 30 has a conveyance motor 32 and a driving part including, for example, a non-illustrated ball screw or non-illustrated rack and pinion. The driving part is connected to the conveyance motor 32. As the conveyance motor 32 is driven to rotate, the platen 11 is caused to move in the conveyance direction Df, thereby conveying the printing medium W is conveyed in the conveyance direction Df.

The moving device 40 has the carriage 41, two guide rails 42, a movement motor 43, and an endless belt 44. The two guide rails 42 extend in the movement direction Ds at a location above the platen 11. The two guide rails 42 is disposed so that the carriage 41 is interposed between the two guide rails 42 in the conveyance direction Df. The carriage 41 supports each of the ejection heads 20. The carriage 41 is supported by the two guide rails 42 so that the carriage 41 is movable in the movement direction Ds. The endless belt 44 extends in the movement direction Ds, and the endless belt 44 is attached to the carriage 41. Further, the endless belt 44 is attached to the movement motor 43 via a pulley 45. As the movement motor 43 is driven to rotate, the endless belt 44 is activated, thereby causing and the carriage 41 to reciprocate in the movement direction Ds along the guide rails 42. Accordingly, each of the ejection heads 20 reciprocates in the movement direction Ds.

The receiving part 54 is disposed adjacent to one ends in the movement direction Ds of the guide rails 42. The receiving part 54 is disposed so that the receiving part 54 overlaps with a movement region, of the carriage 41, which extends in the movement direction Ds. The receiving part 54 receives the ink droplets ejected from the ejection heads 20 in a flushing process. The flushing process is performed in a state that each of the ejection heads 20 is located at a position over the receiving part 54 by the carriage 41. More specifically, the receiving part 54 receives the ink droplets of the white ink discharged from the nozzles 121 of the first ejection head 21, the ink droplets of the special color ink(s) discharged from the nozzles 221 of the second ejection head 22, and the ink droplets of the color inks discharged from the nozzles 321 of the third ejection head 23. Further, in a case where a plurality of flushing processes are necessary, a controller 50 to be described later executes a first flushing process and a second flushing process. In the first flushing process, the ink droplets of the above-described colors are discharged from the nozzles 121, 221, 321 with respect to the receiving part 54. In the second flushing process, the ink droplets of the above-described colors are discharged from the nozzles 121, 221, 321 with respect to the receiving part 54 after the first flushing process. Note that the ink droplets, which are received by the receiving part 54, are exhausted via a non-illustrated piping connected to the receiving part 54.

As depicted in FIG. 2, the first ejection head 21 has a plurality of nozzle arrays NL. Each of the plurality of nozzle arrays NL is constructed of nozzles 121 aligned at predetermined intervals in a predetermined nozzle array direction Dn. That is, each of the plurality of nozzle arrays NL extends in the nozzle array direction Dn. The nozzle array direction Dn is a direction which is, for example, parallel to the conveyance direction Df. The plurality of nozzle arrays NL are disposed side by side at predetermined intervals in the movement direction Ds. The disposition of the nozzle arrays NL of the second ejection head 22 and the disposition of the nozzle arrays NL of the third ejection head 23 may be similar to the disposition of the nozzle arrays NL of the first ejection head 21. Note that in FIG. 2, the nozzles constructing the nozzle arrays NL of the second ejection head 22 are referred to as nozzles 221, and the nozzles constructing the nozzle arrays NL of the third ejection head 23 are referred to as nozzles 321. In the present embodiment, the nozzles 321 correspond to first nozzles configured to eject the first liquid to the printing medium W, and the nozzles 221 correspond to second nozzles configured to eject the second liquid to the printing medium W.

As depicted in FIG. 3, the ejection head 20 has a plurality of driving elements 25. Each of the plurality of driving elements 25 is, for example, a piezoelectric element, a heat generating element, or an electrostatic actuator. Each of the plurality of driving elements 25 applies, to the ink droplet, the pressure for ejecting the ink droplet from the nozzle.

The liquid droplet ejecting apparatus 100 includes a display 14, an input device 15, a temperature measuring part 16, a humidity measuring part 17, and the controller 50. The controller 50 corresponds to a computer, and the controller 50 has an interface 51, a calculating part 52, and a memory 53. The interface 51 receives various data such as image data from an external apparatus 200 including, for example, a computer, a camera, a communication network, a display, a reading device, and a printer. The image data is, for example, raster data representing an image to be printed on the printing medium W. The image data also includes information about a printing condition including, for example, the type of the printing medium W. The controller 50 may be constructed of a single device. Alternatively, the controller 50 may be configured such that a plurality of devices are disposed in a distributed manner, and the devices cooperate to perform the operation of the liquid droplet ejecting apparatus 100.

The memory 53 is a memory which is accessible from the calculating part 52, and the memory 53 has a RAM and a ROM. The RAM temporarily stores various data including, for example, data received from the external apparatus 200 such as, for example, the image data and data converted by the calculating part 52. The ROM stores, for example, a printing program for performing various data processing processes, and predetermined data. The memory 53 as described above previously stores a first lookup table and a second lookup table. The first lookup table is used to convert the image data into first printing data for using only the color inks. The second lookup table is used to convert the image data into second printing data for using both of the color inks and the special color inks. The first lookup table and the second lookup table will be described in detail later. Note that a liquid droplet ejecting program which is to be executed by the liquid droplet ejecting apparatus 100 of the present embodiment may be stored in the memory 53, via the reading device, from any storage medium including, for example, CD-ROM readable by the reading device. Alternatively, the liquid droplet ejecting program may be downloaded, for example, from the internet and stored in the memory 53.

The calculating part 52 includes a processor including, for example, CPU and at least one circuit such as, for example, an integrated circuit including, for example, ASIC. The calculating part executes the liquid droplet ejecting program, and thus the calculating part 52 controls the parts of the liquid ejecting apparatus and executes various operations such as, for example, the printing operation.

The display 14 is, for example, a display. The display 14 displays, for example, an image relevant to the image data in accordance with the instruction of the controller 50. The input device 15 is, for example, buttons, and the input device 15 is operated by a user. The user can issue, to the controller 50, an instruction permitting the color difference to be non-zero as described later, by using the input device 15. Note that the input device 15 may be a touch panel which is integrated with the display 14 into one unit.

The temperature measuring part 16 is, for example, a thermometer. The temperature measuring part 16 measures the temperature in the casing 101 of the liquid droplet ejecting apparatus 100. Further, the humidity measuring part 17 is, for example, a hygrometer. The humidity measuring part 17 measures the humidity in the casing 101 of the liquid droplet ejecting apparatus 100. The information about the temperature measured by the temperature measuring part 16 and the information about the humidity measured by the humidity measuring part 17 are transmitted to the controller 50.

The controller 50 receives the information about the temperature transmitted from the temperature measuring part 16, and the controller 50 receives the information about the humidity transmitted from the humidity measuring part 17.

The controller 50 is electrically connected to a conveyance motor 32 of the conveying device 30 via a conveyance driving circuit 33. The controller 50 controls the rotary action of the conveyance motor 32. Accordingly, the controller 50 controls the conveyance of the printing medium W performed by the conveying device 30. Further, the controller 50 is electrically connected to a movement motor 43 of the moving device 40 by a movement driving circuit 46. The controller 50 controls the driving of the movement motor 43. Accordingly, the controller 50 controls the movement of the ejection head 20 performed by the moving device 40. Further, the controller 50 is electrically connected to the driving element 25 via an ejection head driving circuit 26. The controller 50 outputs the control signal of the driving element 25 to the ejection head driving circuit 26. The ejection head driving circuit 26 generates a driving signal based on the control signal, and the ejection head driving circuit 26 outputs the driving signal to the driving element 25. The driving element 25 is driven in accordance with the driving signal, thereby ejecting the ink droplets from the nozzle.

In the liquid droplet ejecting apparatus 100 constructed as described above, the controller 50 obtains the image data, and the controller 50 executes the printing operation based on the image data. In this case, the controller 50 causes the ejection head 20 to eject the ink droplets to the printing medium W while moving the ejection head 20 in the movement direction Ds in a printing pass. Then, the controller 50 conveys the printing medium W in the conveyance direction Df in a conveyance operation. In this way, the liquid droplet ejecting apparatus 100 alternately repeats the printing pass and the conveyance operation. Accordingly, the image relevant to the image data is printed on the printing medium W.

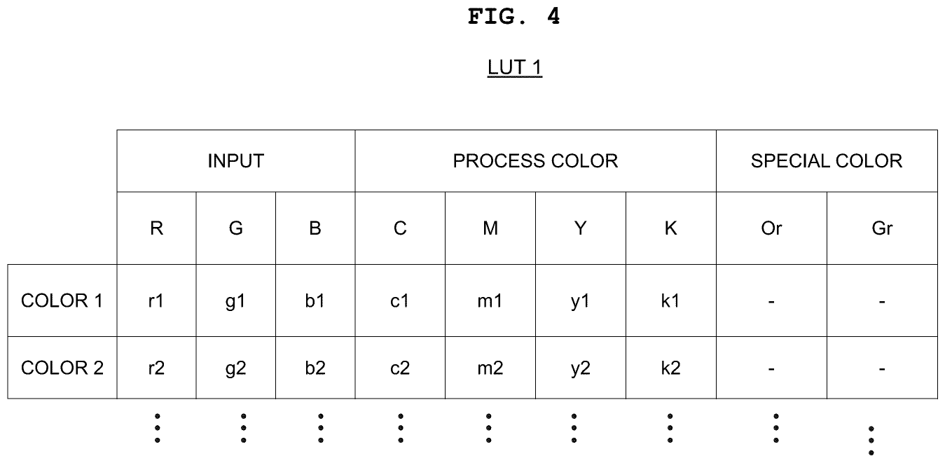

Next, the first lookup table and the second lookup table will be described with reference to FIG. 4 to FIG. 6.

The controller 50 executes a process of ejecting the ink droplets to the printing medium W based on the first lookup table or the second lookup table, depending on the dryness of the nozzles 221 corresponding to the second nozzles. That is, the controller 50 generates first printing data for using only the color inks based on the first lookup table depending on the dryness of the nozzles 221, or the controller 50 generates second printing data for using both of the color inks and the special color inks based on the second lookup table.

The controller 50 determines the dryness of the nozzles 221 based on any one of determination items which are: the temperature measured by the temperature measuring part 16, the humidity measured by the humidity measuring part 17, the type of the special color ink, the combination of the temperature and the humidity, the combination of the temperature and the type of the special color ink, the combination of the humidity and the type of the special color ink, and the combination of the temperature, the humidity and the type of the special color ink. In a case where the dryness of the nozzles 221 is determined based on the temperature singly, the humidity singly, and the temperature and the humidity, the use of either one of the first lookup table and the second lookup table may be determined based on the comparison with a previously set threshold value. Further, in a case where the dryness of the nozzles 221 is determined based on the determination item including the special color ink, weight may be previously assigned, depending on the color of the special color ink. In this case, the use of either one of the first lookup table and the second lookup table may be determined based on the weight. In a case where the temperature or the humidity is included in the determination item, the use of either one of the first lookup table and the second lookup table may be determined based on the comparison between the weight and the threshold value.

As depicted in FIG. 4, a first lookup table LUT1 is a color conversion table. This table is used in a case where the RGB values of a certain color in the image data are converted into a CMYK values (process color values) of the printing data. The first lookup table LUT1 is used to convert the RGB values into the CMYK values, and the first lookup table LUT1 is not used to convert the RGB values into the component value of the special color ink.

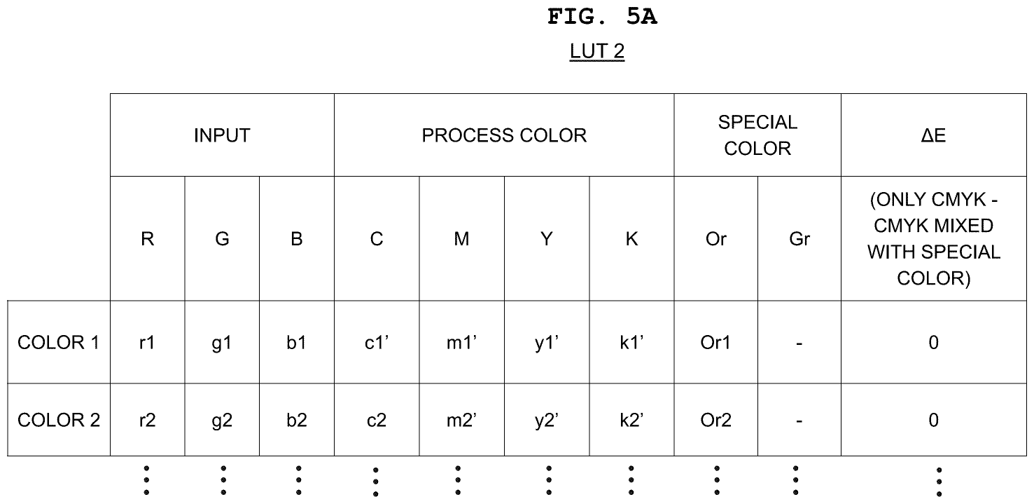

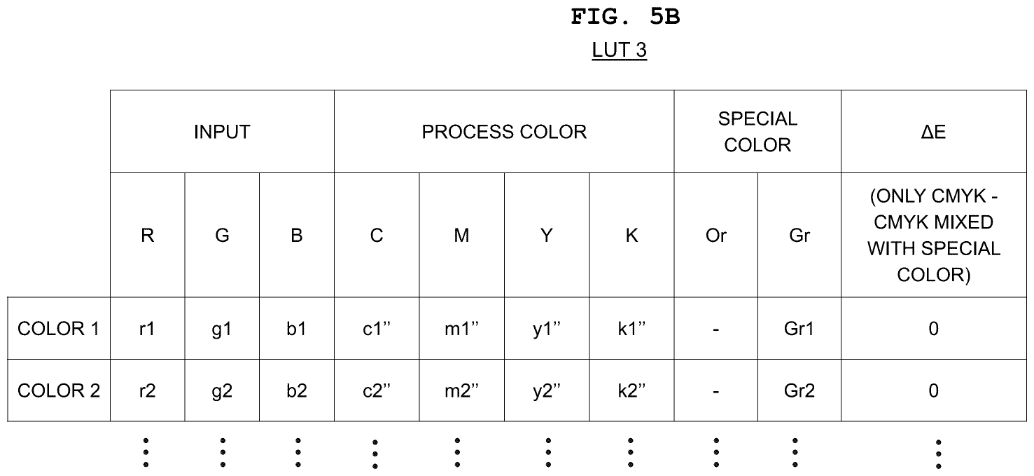

In contrast, as depicted in FIG. 5A, a second lookup table LUT2 is a color conversion table. This table is used in a case where the RGB values of a certain color in the image data are converted into both of the CMYK values in the printing data and the component value of the orange ink as the first special color ink. Similarly, as depicted in FIG. 5B, a second lookup table LUT3 is a color conversion table. This table is used in a case where the RGB values of a certain color in the image data are converted into both of the CMYK values in the printing data and the component value of the green ink as the second special color ink. In this way, the second lookup tables LUT2, LUT3 are used in a case where the RGB values are converted into both of the CMYK values and the component value of a predetermined special color ink. The second lookup tables LUT2, LUT3 are different from the first lookup table LUT1 which is used to convert the RGB values into only the CMYK values.

The second lookup table LUT2 depicted in FIG. 5A and the second lookup table LUT3 depicted in FIG. 5B are views depicting examples of such a case where the color difference is zero between the target color (i.e., the input color) and the output color after the conversion into both of the CMYK values and the component value of the predetermined special color ink. However, the color difference is generated between the target color and the output color in some cases on account, for example, of the ink type and the type of the ejection head 20.

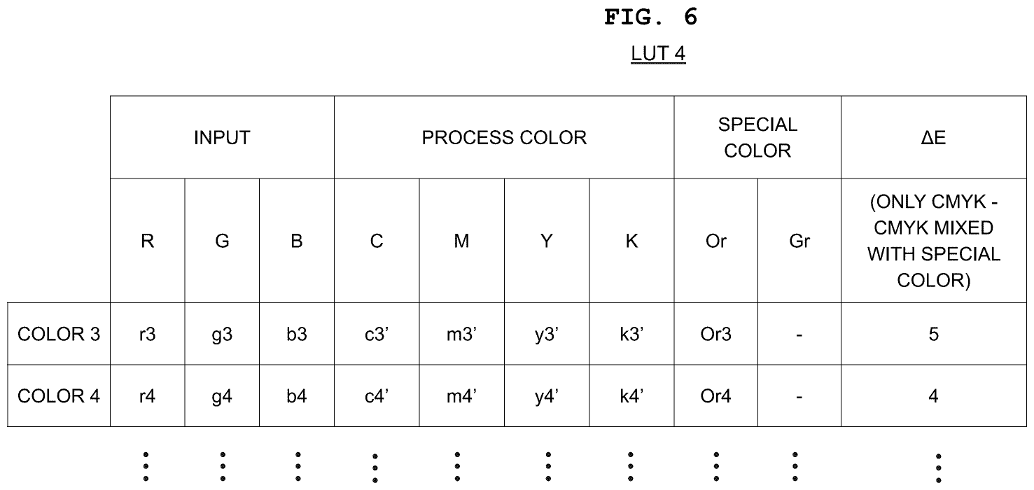

On the other hand, the color difference is not zero between the target color and the output color in some cases after the conversion into both of the CMYK values and the component value of the predetermined special color ink. A second lookup table LUT4 depicted in FIG. 6 depicts such a case where the RGB values is converted into both of the CMYK values and the component value of the predetermined special color ink, and where the color difference (AE) is not zero between the target color and the output color after the conversion into both of the CMYK values and the component value of the predetermined special color ink. On this account, color difference of a certain extent occurs in a case where the color conversion is performed based on the second lookup table LUT4. Note that the second lookup table LUT4 previously stores the value relevant to the color difference calculated after the color measurement using a colorimetric device.

Even in a case where the color difference occurs between the target color and the output color after the conversion into both of the CMYK values and the component value of the predetermined special color ink as described above, the user can input, to the controller 50, the instruction permitting the color difference to be non-zero, as described above, by using the input device 15. In other words, the controller 50 can receive, from the user, the instruction permitting the color difference to be non-zero between the first color as the color in which the image data is outputted based on the first printing data (printing data for using only the color inks) and the second color as the color in which the image data is outputted based on the second printing data (printing data using both of the color ink and the special color ink). In this case, in a case where the user uses the input device 15 to issue the above-described instruction to the controller 50, the controller 50 executes a receiving process of receiving the instruction. In this way, in a case where the controller 50 receives, from the user, the instruction permitting the color difference to be non-zero, the controller 50 refers to the second lookup table LUT4. On the other hand, in a case where the user does not issue the instruction permitting the color difference to be non-zero, i.e., in a case where the user does not wish to perform the printing in a state that the color difference occurs, the controller 50 refers to the first lookup table LUT1 in order to perform the conversion into the first printing data not using the special color ink.

Next, in a case where the controller 50 refers to the second lookup table LUT4, the controller 50 executes a process of obtaining the color difference between the first color as the color which is outputted based on the first printing data and the second color as the color which is outputted based on the second printing data. Regarding the example depicted in FIG. 6, for example, color difference 5 is obtained with respect to color 3. Note that the obtainment of the color difference by the controller 50 means reading the value relevant to the color difference from the second lookup table LUT4. Regarding the example depicted in FIG. 6, for example, the controller 50 reads the color difference 5 with respect to the color 3.

Next, the controller 50 executes a process of determining whether the obtained color difference is a previously determined threshold value or less. In a case where the obtained color difference is the color difference 5, the controller 50 determines that the obtained color difference is the threshold value or less. Thus, the controller 50 generates the second printing data by converting the image data based on the second lookup table LUT4. Then, the controller 50 causes the ink droplets of the color ink to be ejected from the second nozzle 321 to the printing medium W based on the second printing data, and the controller 50 causes the ink droplets of the special color ink to be ejected from the nozzles 221 to the printing medium W. Note that the threshold value may be determined to be the color difference 5 as a value which can be sensed as a general visual characteristic, or the threshold value may be determined to be a desired value by the user.

In contrast, in a case where the color difference is more than the threshold value, for example, in a case where the color difference exceeds the color difference 5, the controller 50 generates the first printing data by converting the image data based on the first lookup table LUT1. Then, the controller 50 causes the third ejection head 23 to eject the ink droplets of the color ink from the nozzles 321 to the printing medium W based on the first printing data. In other words, the controller 50 refers to the first lookup table LUT1, and the controller 50 causes the ink droplets of the color ink to be ejected from the nozzles 321 to the printing medium W based on the first lookup table LUT1.

In this situation, unlike the foregoing case where the user issues the instruction permitting the color difference to be non-zero, in a case where the user does not issue the above-described instruction, the controller 50 executes the following process. That is, the controller 50 determines whether a region which includes a high frequency component and which has a predetermined area or more is present in the image based on the image data. In this case, the controller 50 executes a frequency converting process with respect to the image data so as to obtain a frequency map in which the intensity of the two-dimensional spatial frequency component (specifically, for example, high frequency component, middle frequency component, and low frequency component) is extracted. Then, the controller 50 determines whether the region, which includes the high frequency component and which has the predetermined area or more, is present in the frequency map. Note that rather than obtaining the frequency map, the controller 50 may obtain, for example, a spectrum indicating the intensity of the two-dimensional special frequency component. Further, the frequency converting process is exemplified, for example, by known processes including, for example, the fast Fourier transform (FFT) and the edge detection process.

In a case where the region which includes the high frequency component and which has the predetermined area or more is present in the frequency map, the controller 50 refers to the second lookup table LUT4. On the other hand, in a case where the region which includes the high frequency component and which has the predetermined area or more is not present in the frequency map, the controller 50 refers to the first lookup table LUT1.

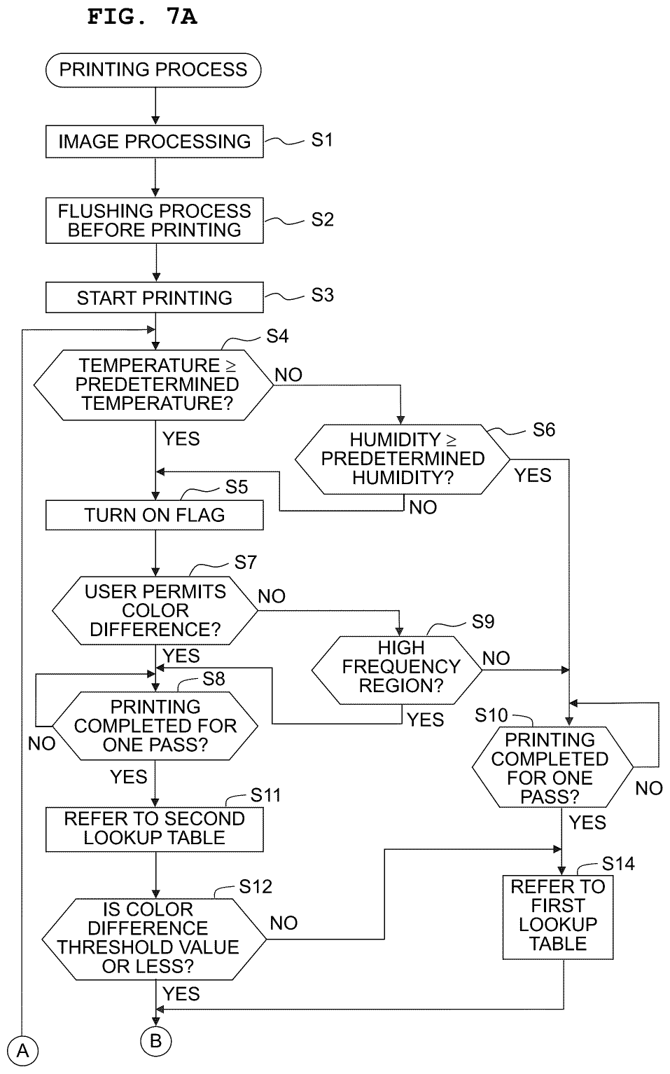

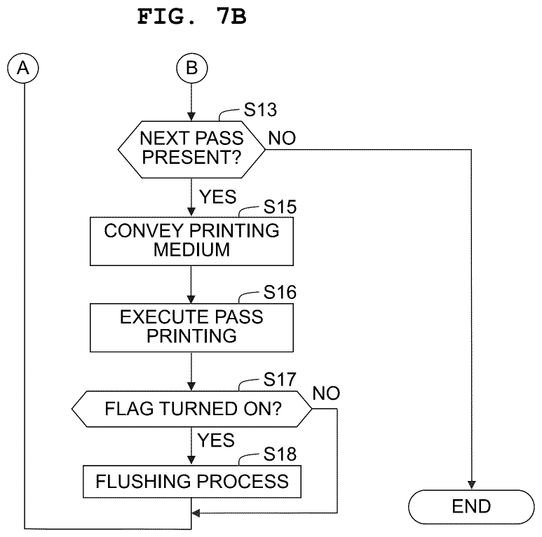

A series of process flows performed by the controller 50 as described above will be described with reference to a flow chart depicted in FIGS. 7A and 7B.

At first, the controller 50 executes a frequency converting process with respect to the image data to obtain the frequency map in which the intensity of the two-dimensional spatial frequency component (specifically, high frequency component, middle frequency component, and low frequency component) is extracted (Step S1).

Subsequently, the controller 50 executes the flushing process before starting the printing (Step S2). In this procedure, the controller 50 causes the carriage 41 to move the ejection heads 20 to the positions above the receiving part 54, and ejects the ink droplets from the nozzles 121, 221, 321 toward the receiving part 54 in this state.

After that, the controller 50 starts the printing so as to cause the third ejection head 23 to eject the ink droplets of the color inks in the first pass (Step S3). In this procedure, the controller 50 refers to the first lookup table LUT1, converts the image data (in particular, the data of a portion corresponding to the first pass of the image data) into the first printing data, and causes the third ejection head 23 to eject the ink droplets based on the first printing data.

Subsequently, the controller 50 obtains the temperature measured by the temperature measuring part 16, and the controller 50 determines whether the temperature is a predetermined temperature or more (Step S4). In a case where the controller 50 determines that the temperature is the predetermined temperature or more (Yes in Step S4), the controller 50 can presume that the dryness of the nozzles 221 is great. Therefore, the controller 50 turns ON a flag regarding the flushing process to be carried out in the following step (Step S5).

On the other hand, in a case where the controller 50 determines that the temperature is less than the predetermined temperature (No in Step S4), the controller 50 obtains the humidity measured by the humidity measuring part 17, and the controller 50 determines whether the humidity is a predetermined humidity or more (Step S6). In a case where the controller 50 determines that the humidity is less than the predetermined humidity (No in Step S6), the controller 50 can presume that the dryness of the nozzles 221 is great. Therefore, the controller 50 turns ON the flag regarding the flushing process to be carried out in the following step (Step S5). In contrast, in a case where the controller 50 determines that the humidity is the predetermined humidity or more (Yes in Step S6), the controller 50 continues the printing with respect to the first pass, and the controller 50 determines whether the printing with respect to the first pass is completed (Step S10).

After Step S5, the controller 50 determines whether the instruction has been received from the user, the instruction permitting the color difference to be non-zero between the first color as the color in which the image data is outputted based on the first printing data (printing data for using only the color ink) and the second color as the color in which the image data is outputted based on the second printing data (printing data using both of the color ink and the special color ink) (Step S7). In a case where the controller 50 determines that the above-described instruction has been received (Yes in Step S7), the controller 50 continues the printing with respect to the first pass, and the controller 50 determines whether the printing is completed with respect to the first pass (Step S8).

On the other hand, in a case where the controller 50 determines that the above-described instruction has not been received (No in Step S7), the controller 50 determines whether the region, which includes the high frequency component and which has a predetermined area or more, is present in a portion corresponding to the next printing pass (for example, the second pass) of the image based on the image data (Step S9). In a case where the controller 50 determines that the region, which has the predetermined area or more, is present (Yes in Step S9), the controller 50 executes the process of Step S8 described above. In contrast, in a case where the controller 50 determines that the region, which has the predetermined area or more, is not present (No in Step S9), the controller 50 executes the process of Step S10 described above.

After that, in a case where the printing is completed with respect to the first pass (Yes in Step S8), the controller 50 refers to the second lookup table LUT4 in order to generate the second printing data by converting the data of the portion corresponding to the next printing pass (for example, the second pass) of the image data (Step S11).

Next, the controller 50 determines whether the color difference in the second lookup table LUT4 is a threshold value less (Step S12). In a case where the controller 50 determines that the color difference is the threshold value or less (Yes in Step S12), the controller 50 executes the process of Step S13 described below. In contrast, in a case where the controller 50 determines that the color difference is more than the threshold value (No in Step S12), and in a case where the controller 50 determines that the printing is completed with respect to the first pass (Yes in Step S10), the controller 50 refers to the first lookup table LUT1 in order to generate the first printing data by converting the data of the portion corresponding to the next printing pass (for example, the second pass) of the image data (Step S14). After that, the controller 50 executes the process of Step S13 described below.

In the process of Step S13, the controller 50 determines whether the next printing pass is present. In a case where the controller 50 determines that the next printing pass is absent (No in Step S13), the controller 50 ends the printing process.

In contrast, in a case where the controller 50 determines that the next printing pass is present (Yes in Step S13), the controller 50 conveys, by using the platen 11, the printing medium W by an amount corresponding to one pass in the conveyance direction Df (Step S15). Then, the controller 50 generates the printing data corresponding to the next printing pass based on the lookup table which is either one of the first lookup table LUT1 and the second lookup table LUT4 and which has been referred to in the foregoing step, and the controller 50 executes the printing based on the printing data (Step S16).

Next, the controller 50 determines whether the flag regarding the flushing process is turned ON in the process of Step S5 described above (Step S17). In a case where the controller 50 determines that the flag regarding the flushing process is turned ON (Yes in Step S17), the controller 50 executes the flushing process (Step S18). Then, after the process of Step S18, and in a case where the controller 50 determines that the flag regarding the flushing process is not turned ON (No in Step S17), the controller 50 returns to the process of Step S4 and repeats the process of step S4 and the process after the process of step S4.

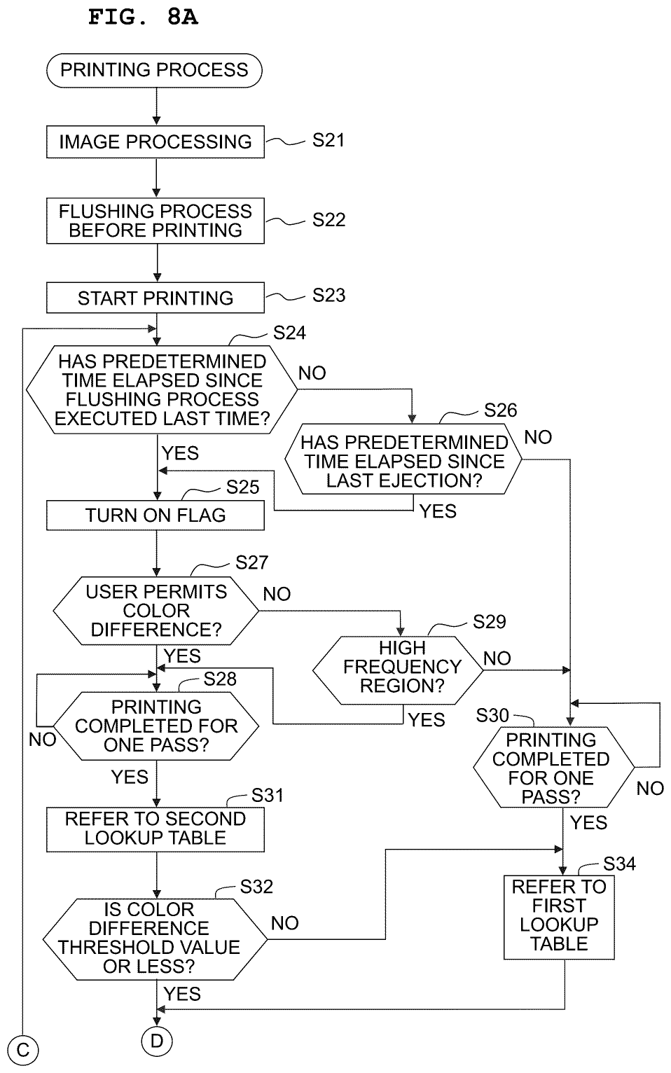

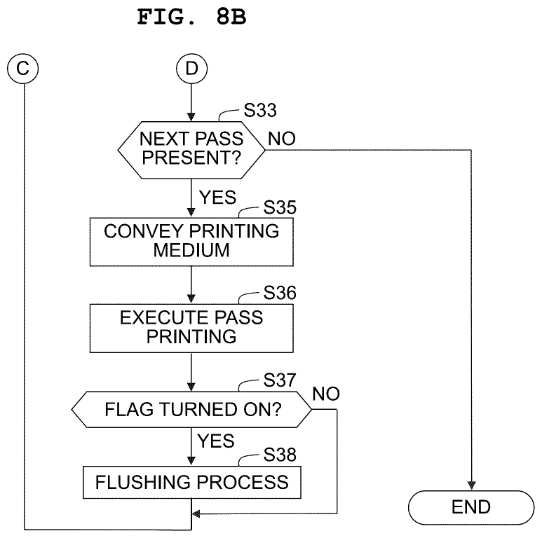

Next, another example of the flow of the process in the liquid droplet ejecting apparatus 100 will be described with reference to FIGS. 8A and 8B.

At first, the controller 50 executes a frequency converting process with respect to the image data to obtain a frequency map in which the intensity of the two-dimensional spatial frequency component (specifically, high frequency component, middle frequency component, and low frequency component) is extracted (Step S21).

Subsequently, the controller 50 executes the flushing process before starting the printing (Step S22). In this procedure, the controller 50 causes the carriage 41 to move the ejection heads 20 to the positions above the receiving part 54, and causes the ink droplets to be discharged from the nozzles 121, 221, 321 toward the receiving part 54 in this state.

After that, the controller 50 starts the printing of ejecting the ink droplets of the color inks from the third ejection head 23 in the first pass (Step S23). In this procedure, the controller 50 refers to the first lookup table LUT1 to convert the image data (in particular, the data of the portion corresponding to the first pass of the image data) into the first printing data, and causes the ink droplets to be ejected from the third ejection head 23 based on the first printing data.

Next, the controller 50 determines whether the predetermined time has elapsed since the flushing process executed last time (Step S24). In a case where the controller 50 determines that the predetermined time has elapsed since the flushing process executed immediately before (Yes in Step S24), the controller 50 can presume that the dryness of the nozzles 221 is great. Therefore, the controller 50 turns ON the flag regarding the flushing process to be carried out in the following step (Step S25). In other words, the controller 50 determines the dryness of the nozzles 221 based on the elapsed time since the flushing process executed immediately before. Note that the controller 50 does not execute any flushing process after the flushing process executed last time and until Step S24.

In contrast, in a case where the controller 50 determines that the predetermined time has not elapsed since the flushing process executed immediately before (No in Step S24), the controller 50 determines whether the predetermined time has elapsed since the ejection of the ink droplets from the nozzles 221 performed last time (hereinafter referred to as the “last ejection of the ink droplets”, in some cases) (Step S26). In a case where the controller 50 determines that the predetermined time has elapsed since the last ejection of the ink droplets from the nozzles 221 (Yes in Step S26), the controller 50 can presume that the dryness of the nozzles 221 is great. Therefore, the controller 50 turns ON the flag regarding the flushing process to be carried out in the following step (Step S25). In contrast, in a case where the controller 50 determines that the predetermined time has not elapsed since the last ejection of the ink droplets from the nozzles 221 (No in Step S26), the controller 50 continues the printing with respect to the first pass, and the controller 50 determines whether the printing is completed with respect to the first pass (Step S30).

Subsequently, the controller 50 determines whether the instruction has been received from the user, the instruction permitting the color difference to be non-zero between the first color as the color in which the image data is outputted based on the first printing data (printing data for using only the color ink) and the second color as the color in which the image data is outputted based on the second printing data (printing data using both of the color ink and the special color ink) (Step S27). In a case where the controller 50 determines that the above-described instruction has been received (Yes in Step S27), the controller 50 continues the printing with respect to the first pass, and the controller 50 determines whether the printing is completed with respect to the first pass (Step S28).

In contrast, in a case where the controller 50 determines that the above-described instruction has not been received yet (No in Step S27), the controller 50 determines whether the region, which includes the high frequency component and which has a predetermined area or more, is present in the portion corresponding to the next printing pass (for example, the second pass) of the image based on the image data (Step S29). In a case where the controller 50 determines that the region, which has the predetermined area or more, is present (Yes in Step S29), the controller 50 executes the process of Step S28 described above. In contrast, in a case where the controller 50 determines that the region has less than the predetermined area (No in Step S29), the controller 50 executes the process of Step S30 described above.

After that, in a case where the controller 50 determines that the printing is completed with respect to the first pass (Yes in Step S28), the controller 50 refers to the second lookup table LUT4 in order to generate the second printing data by converting the data of the portion corresponding to the next printing pass (for example, the second pass) of the image data (Step S31).

Next, the controller 50 determines whether the color difference in the second lookup table LUT4 is a threshold value or less (Step S32). In a case where the controller 50 determines that the color difference is the threshold value or less (Yes in Step S32), the controller 50 executes the process of Step S33 described below. In contrast, in a case where the controller 50 determines that the color difference is greater than the threshold value (No in Step S32), and in a case where the controller 50 determines that the printing is completed with respect to the first pass (Yes in Step S30), the controller 50 refers to the first lookup table LUT1 in order to generate the first printing data by converting the data of the portion corresponding to the next printing pass (for example, the second pass) of the image data (Step S34). After that, the controller 50 executes the process of Step S33 described below.

In the process of Step S33, the controller 50 determines whether the next printing pass is present. In a case where the controller 50 determines that the next printing pass is absent (No in Step S33), the controller 50 ends the printing process.

In contrast, in a case where the controller 50 determines that the next printing pass is present (Yes in Step S33), the controller 50 conveys, using the platen 11, the printing medium W by an amount of one pass in the conveyance direction Df (Step S35). Then, the controller 50 generates the printing data corresponding to the next printing pass based on the lookup table which is either one of the first lookup table LUT1 and the second lookup table LUT4 and which has been referred to in the foregoing step, and the controller 50 executes the printing based on the printing data (Step S36).

Next, the controller 50 determines whether the flag is turned ON regarding the flushing process in the process of Step S25 described above (Step S37). In a case where the controller 50 determines that the flag regarding the flushing process is turned ON (Yes in Step S37), the controller 50 executes the flushing process (Step S38). Then, after the process of Step S38, and in a case where the controller 50 determines that the flag regarding the flushing process is not turned ON (No in Step S37), the controller 50 returns to the process of Step S24 to repeat the process of step S24 and the steps following the process of step S24.

As described above, in the liquid droplet ejecting apparatus 100 of the present embodiment, the memory 53 previously stores the second lookup tables LUT2, LUT3, and LUT4 for converting the image data into the second printing data using both of the color ink and the special color ink. Further, the ink droplets of the color ink are ejected from the nozzles 321 to the printing medium W based on the second lookup table LUT2, LUT3 or LUT4 depending on the dryness of the nozzles 221, and the ink droplets of the special color ink are ejected from the nozzles 221 to the printing medium W. In this way, the special color ink is ejected while being overlapped with the color ink based on the second lookup table LUT2, LUT3 or LUT4 to a region, in the printing medium W, in which the ejection of the special color ink is not originally necessary. Thus, the periodic ejection of the special color ink is realized using the nozzles 221. Accordingly, the occurrence of the drying in the nozzles 221 is reduced, and thus the occurrence of ejection failure can be made less likely.

Further, in the present embodiment, the dryness of the nozzles 221 is determined based on any one of the determination items including: the temperature measured by the temperature measuring part 16, the humidity measured by the humidity measuring part 17, the type of the special color ink, the combination of the temperature and the humidity, the combination of the temperature and the type of the special color ink, the combination of the humidity and the type of the special color ink, and the combination of the temperature, the humidity and the type of the special color ink. The dryness of the nozzles 221 can be appropriately determined using the determination items as described above.

Furthermore, in the present embodiment, in a case where the user issues the instruction permitting the color difference to be non-zero, the controller 50 refers to the second lookup tables LUT2, LUT3 or LUT4. In this way, based on the request of the user, the printing process of ejecting the ink droplets of the color ink from the nozzles 321 to the printing medium W and of ejecting the ink droplets of the special color ink from the nozzles 221 to the printing medium W can be executed. Accordingly, the occurrence of the drying in the nozzles 221 can be reduced.

Moreover, in the present embodiment, the controller 50 determines whether the region, which includes the high frequency component in the frequency map and which has the predetermined area or more, is present. In a case where the controller 50 determines that the region, which includes the high frequency component in the frequency map and which has the predetermined area or more, is present, the controller 50 refers to the second lookup table LUT4. In a case where the region, which includes the high frequency component and which has the predetermined area or more, is present, the reproducibility of the color is not lowered greatly even in a case where the special color ink is ejected to the region together with the color ink. In such a situation, the printing process of ejecting the ink droplets of the color ink from the nozzles 321 to the printing medium W, and of ejecting the ink droplets of the special color ink from the nozzles 221 to the printing medium W is executed, thereby reducing the occurrence of the drying in the nozzles 221.

Further, in the present embodiment, in a case where the controller 50 determines that the color difference is greater than the threshold value, the controller 50 converts the image data based on the first lookup table LUT1, and thus the controller 50 generates the first printing data. Then, the controller 50 causes the ink droplets of the color ink to be ejected from the nozzles 321 to the printing medium W based on the first printing data. In this case, even in a case where the user issues the instruction permitting the color difference to be non-zero, but where the color difference is greater than the threshold value, the printing process of ejecting the ink droplets of the color ink from the nozzles 321, without ejecting the ink droplets of the special color ink from the nozzles 221, is executed. Accordingly, the printing can be performed while prioritizing the reproducibility of the color on the printing medium W.

Furthermore, in the present embodiment, the dryness of the nozzles 221 is determined based on the elapsed time since the flushing process performed last or the elapsed time since the last ejection from the nozzles 221. Accordingly, the dryness of the nozzles 221 may be appropriately determined.

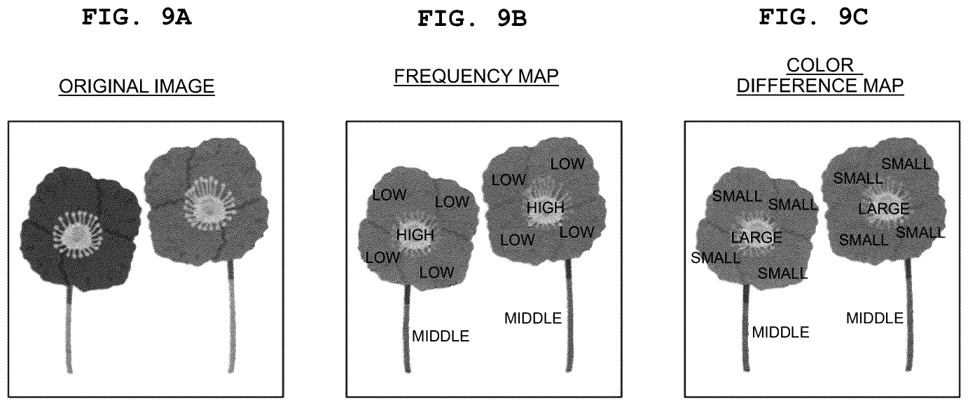

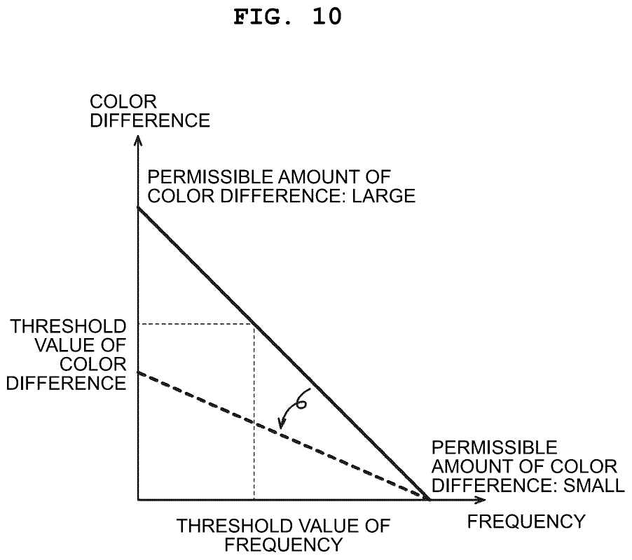

Note that the present disclosure is not limited to the embodiments described above, and the present disclosure can adopt modifications within the range not departing from the gist or characteristics of the present disclosure. The modifications will be described with reference to FIG. 9A to FIG. 10.

The frequency map depicted in FIG. 9B is obtained by the controller 50 executing the frequency converting process with respect to an image (original image) regarding the image data depicted in FIG. 9A. In the frequency map depicted in FIG. 9B, a region corresponding to the high frequency component is indicated as “high”, a region corresponding to the middle frequency component is indicated as “middle”, and a region corresponding to the low frequency component is indicated as “low”. Further, the color difference map depicted in FIG. 9C depicts the color difference to be reproduced corresponding to each of the regions of the frequency map depicted in FIG. 9B. In the color difference map depicted in FIG. 9C, a region having a great color difference is indicated as “great”, a region having a small color difference is indicated as “small”, and a region having a middle color difference is indicated as “middle”. Furthermore, FIG. 10 depicts the relationship between the frequency component and the permissible amount of the color difference instructed by the user, and the relationship can be obtained from a predetermined table or calculation.

This example is constructed so that the permissible amount of the color difference can be instructed by the user. Then, the controller 50 obtains the frequency component corresponding to the permissible amount of the color difference instructed by the user, based on a solid line which indicates the relationship between the permissible amount of the color difference and the frequency component. For example, in a case where the user does not permit the great color difference (i.e., in a case where the user permits the minimum amount of the color difference), for example, the special color ink having the small color difference in the second lookup table LUT4 is ejected to the region of the high frequency component in the frequency map depicted in FIG. 9B. In contrast, in a case where the user permits the great color difference, for example, the special color ink having the great color difference in the second lookup table LUT4 is ejected to the region of the low frequency component in the frequency map depicted in FIG. 9B. Note that the threshold value of the color difference and the threshold value of the frequency may be appropriately adjusted based on the permissible amount of the color difference instructed by the user. Further, the inclination of the solid line indicating the relationship between the permissible amount of the color difference and the frequency component depicted in FIG. 10 may be appropriately changed as indicated by a broken line.

Furthermore, in the embodiment described above, the threshold value regarding the color difference may be adjusted, for example, based on whether the object to be printed on the printing medium W is a document or a photograph. For example, in a case where the object to be printed on the printing medium W is the document, the importance of the color reproducibility is relatively small. Therefore, the threshold value may be raised.

Moreover, in the embodiment described above, the ejection heads are disposed and aligned in the order of the first ejection head 21, the second ejection head 22, and the third ejection head 23, from the one side in the conveyance direction Df. The present disclosure, however, is not limited to this. The order of disposition in the conveyance direction Df of the first ejection head 21, the second ejection head 22, and the third ejection head 23 can be appropriately changed.

Further, in the embodiment described above, the dryness of the second nozzles has been described as exemplified by the nozzles 221 configured to eject the special color ink, as an example. The present disclosure, however, is not limited to this. The ejection process may be performed with reference to each of the lookup tables depending on the dryness of, for example, the nozzles 121 configured to eject the white ink, the nozzles 321 configured to eject the color ink, or the nozzles configured to eject the clear ink.

Furthermore, in the embodiment described above, the ink droplets of the special color ink may be ejected adjacent to the ink droplets of the color having a relatively high erosion rate (for example, black or yellow). In this case, the special color ink is easily eroded by the ink droplets of, for example, the black ink. Therefore, the special color ink is less likely to be conspicuous.

Moreover, in the embodiment described above, the liquid droplet ejecting apparatus 100 includes the temperature measuring part 16. However, the temperature may be measured by any different method. For example, although the first ejection head 21, the second ejection head 22, and the third ejection head 23 eject the ink droplets by applying the voltage in accordance with the ejection waveform, the temperatures of the inks in the first ejection head 21, the second ejection head 22, and the third ejection head 23 may be presumed based on the shapes of the pressure waves remaining in the first ejection head 21, the second ejection head 22, and the third ejection head 23 after the ejection of the ink droplets, i.e., based on the shapes of the remaining pressure waves in the first ejection head 21, the second ejection head 22, and the third ejection head 23. Alternatively, the first ejection head 21, the second ejection head 22, and the third ejection head 23 have the piezoelectric elements. Since the piezoelectric element can be regarded as a capacitor, the capacitance of the piezoelectric element changes depending on the temperature of the ink. Therefore, the temperatures of the inks may be presumed with respect to the first ejection head 21, the second ejection head 22, and the third ejection head 23 based on the capacitances of the piezoelectric elements.

What is claimed is:

1. A liquid droplet ejecting apparatus, comprising:
an ejection head having first nozzles configured to eject a first liquid to a printing medium and second nozzles configured to eject a second liquid different from the first liquid to the printing medium;
a memory; and
a controller,
wherein the memory stores a first lookup table for converting image data into first printing data for using only the first liquid, and a second lookup table for converting the image data into second printing data for using both of the first liquid and the second liquid, and
the controller is configured to cause the ejection head to eject liquid droplets to the printing medium based on the first lookup table or the second lookup table, depending on dryness of the second nozzles.

2. The liquid droplet ejecting apparatus according to claim 1, further comprising a temperature measuring part and a humidity measuring part,
wherein the controller is configured to determine the dryness of the second nozzles based on any one of temperature measured by the temperature measuring part, humidity measured by the humidity measuring part, a type of the second liquid, a combination of the temperature and the humidity, a combination of the temperature and the type of the second liquid, a combination of the humidity and the type of the second liquid, or a combination of the temperature, the humidity and the type of the second liquid.

3. The liquid droplet ejecting apparatus according to claim 1, wherein
the controller is configured to receive, from a user, an instruction permitting a color difference to be non-zero between a first color outputted based on the first printing data and a second color outputted based on the second printing data, and
the controller is configured to refer to the second lookup table, in a case where the controller receives the instruction permitting the color difference to be non-zero.

4. The liquid droplet ejecting apparatus according to claim 3, wherein
in a case where the controller does not receive the instruction permitting the color difference to be non-zero, the controller is configured to determine whether a region including a high frequency component and having a predetermined area or more is present in an image based on the image data, and
in a case where the controller determines that the region including a high frequency component and having the predetermined area or more is present in the image, the controller is configured to refer to the second lookup table.

5. The liquid droplet ejecting apparatus according to claim 1, wherein the controller is configured to:
obtain a color difference between a first color to be outputted based on the first printing data and a second color to be outputted based on the second printing data;
determine whether the color difference is a threshold value or less; and
cause the ejection head to eject the liquid droplets from the first nozzles to the printing medium based on the first lookup table, in a case where the color difference is greater than the threshold value.

6. The liquid droplet ejecting apparatus according to claim 1, further comprising a receiving part configured to receive the liquid droplets discharged from the second nozzles,
wherein the controller is configured to execute:
a first flushing process of discharging the liquid droplets from the second nozzles to the receiving part;
a second flushing process of discharging the liquid droplets from the second nozzles to the receiving part after the first flushing process; and
a process of determining the dryness of the second nozzles based on an elapsed time since the second flushing process.

7. The liquid droplet ejecting apparatus according to claim 1, wherein the controller is configured to determine the dryness of the second nozzles based on an elapsed time since last ejection of the liquid droplets from the second nozzles.

8. A liquid droplet ejecting method using a liquid droplet ejecting apparatus, the liquid ejecting apparatus including: an ejection head having first nozzles configured to eject a first liquid to a printing medium and second nozzles configured to eject a second liquid different from the first liquid to the printing medium, and a memory storing a first lookup table for converting image data into first printing data for using only the first liquid and a second lookup table for converting the image data into second printing data for using both of the first liquid and the second liquid,
the liquid droplet ejecting method comprising causing the ejection head to eject liquid droplets to the printing medium based on the first lookup table or the second lookup table, depending on dryness of the second nozzles.

9. A non-transitory medium storing a program for a liquid droplet ejecting apparatus, the liquid droplet ejecting apparatus including an ejection head having first nozzles configured to eject a first liquid to a printing medium and second nozzles configured to eject a second liquid different from the first liquid to the printing medium, a memory storing a first lookup table for converting image data into first printing data for using only the first liquid and a second lookup table for converting the image data into second printing data for using both of the first liquid and the second liquid, and a controller,
the program for the liquid droplet ejecting apparatus causing the controller to execute: a process of causing the ejection head to eject liquid droplets to the printing medium based on the first lookup table or the second lookup table, depending on dryness of the second nozzles.
